(19) United States
(12) Patent Application Publication
(10) Pub. No.: US 2006/0037314 A1
(43) Pub. Date: Feb. 23, 2006

(54) Energy multiplier

(76) Inventor: Tomislav Vucetic, Miami, FL (US)

Correspondence Address: TOMISLAV VUCETIC, 18021 Biscayne Blvd # 301, MIAMI, FL, 33160, US

(21) Appl. No.: 10/922,653

(22) Filed: Aug. 20, 2004

(51) Int. Cl. F03B 17/02

(52) U.S. Cl. 60/495

(57) ABSTRACT

Invention explains how to get more energy than energy is spent using gravitational and buoyant forces and under which conditions this is possible.

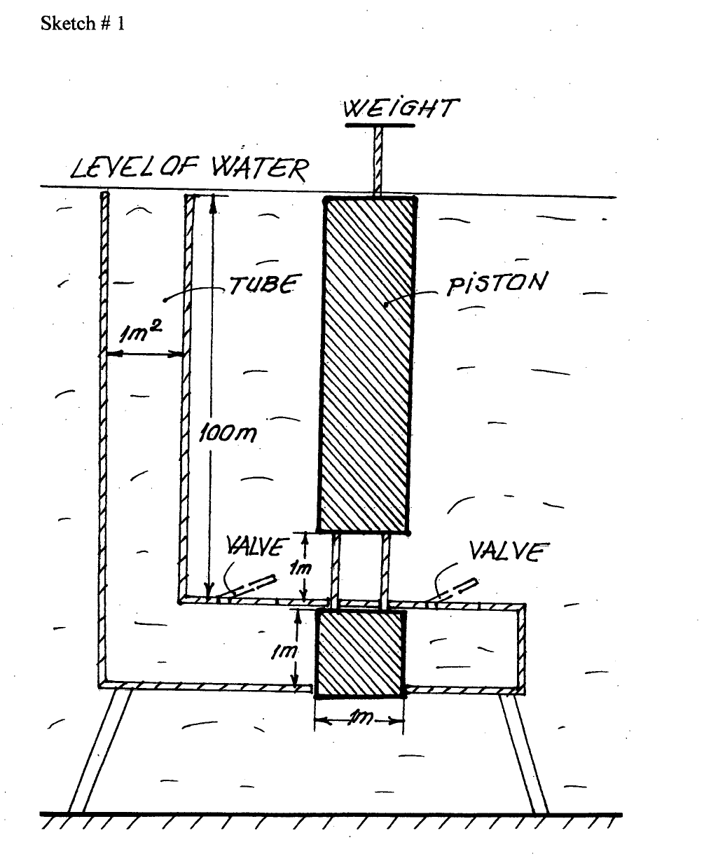

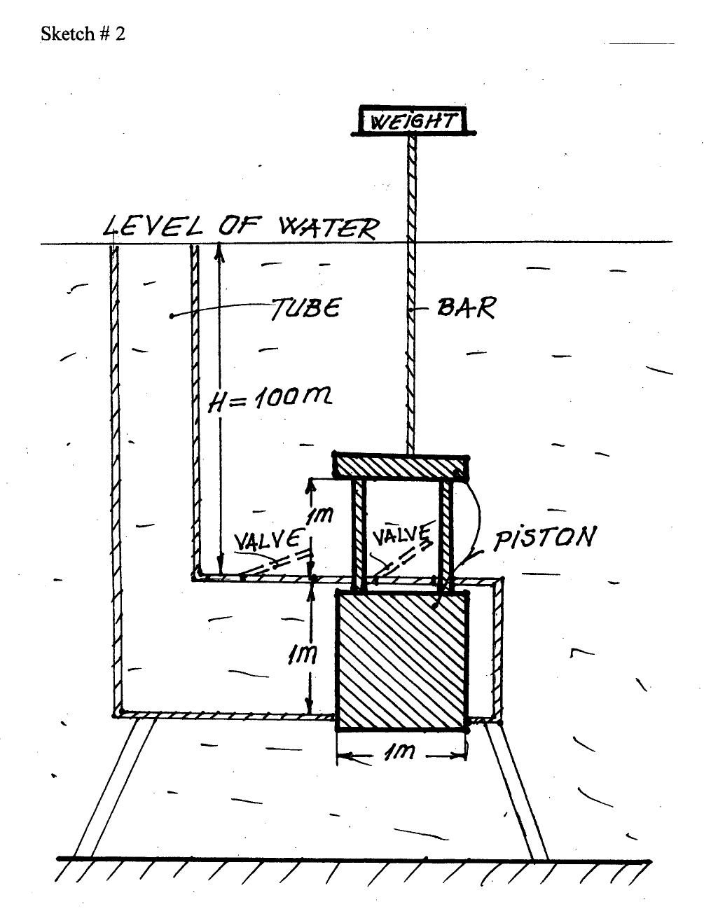

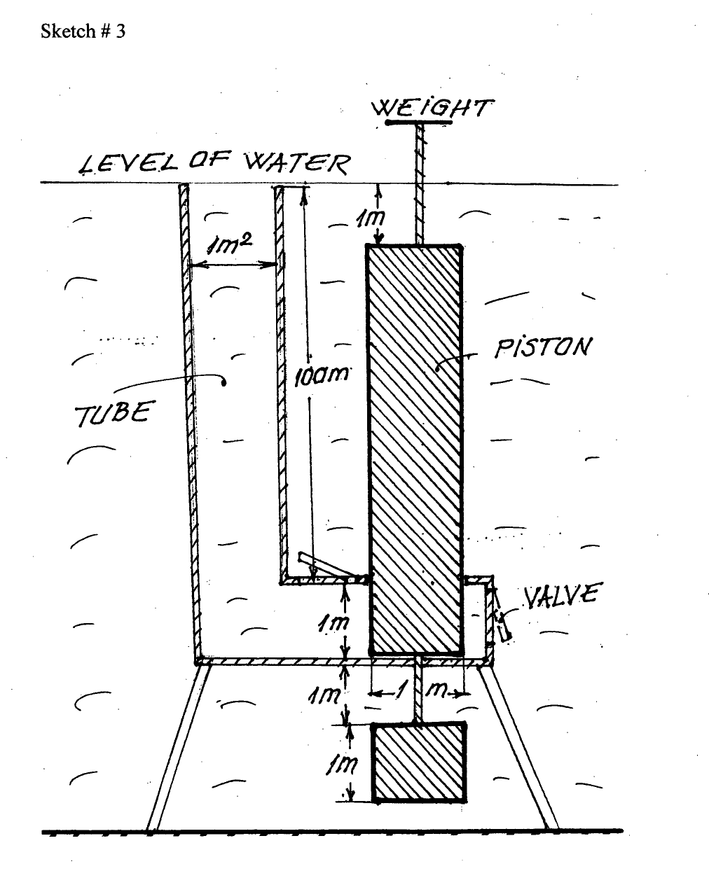

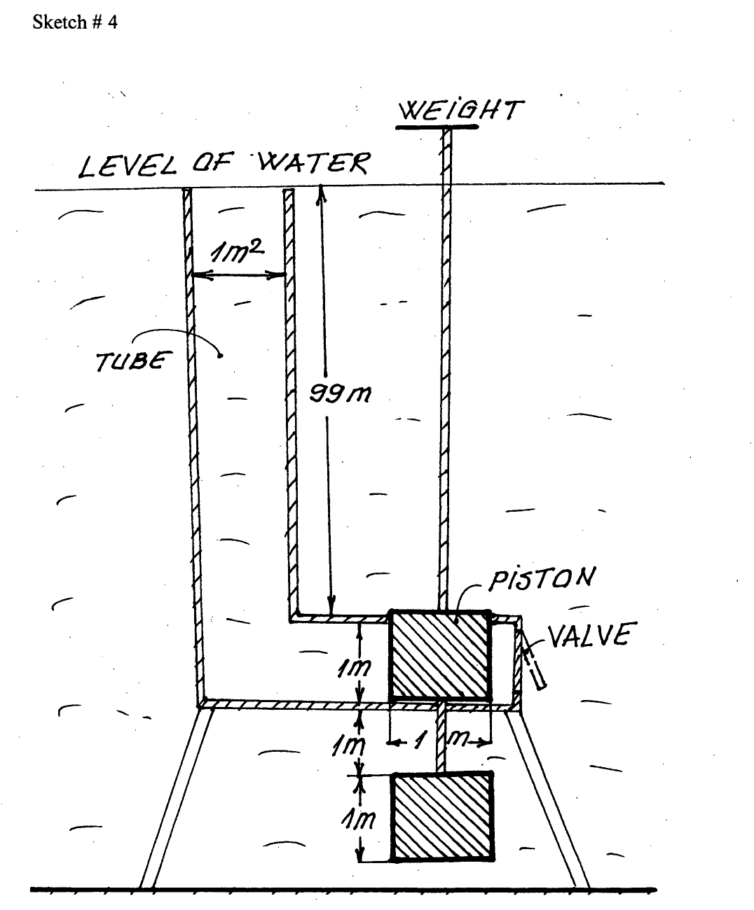

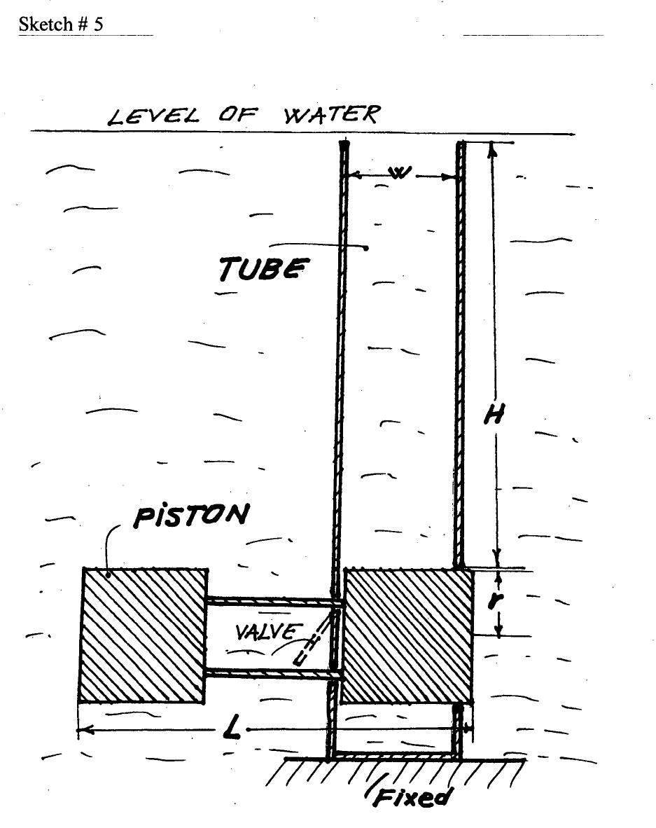

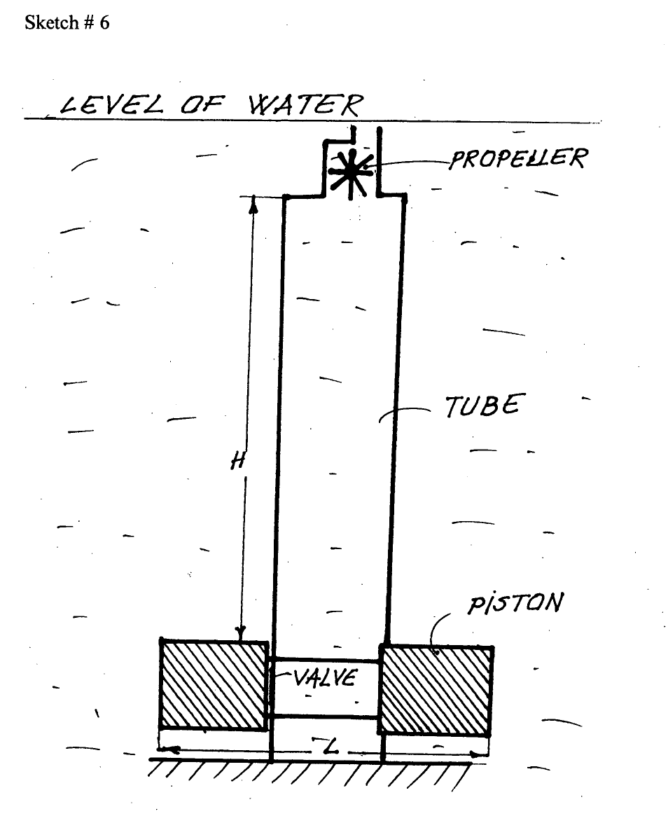

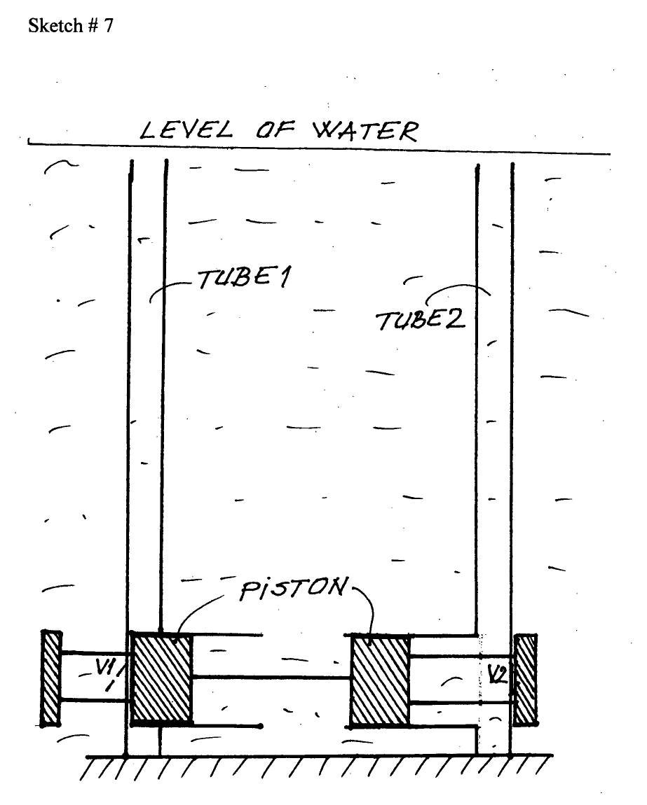

### REFERNCES AND RELATED APPLICATION

Not applicable

### STATEMENT REGARDING FEDERALY SPONSORED RESEARSH

Not applicable

### REFERENCE TO SEQUENCE LISTING TABLE

Not applicable

### BACKGROUND OF INVENTION

Energy generation

### BRIF SUMMARY OF INVENTION

Invention describes method how to multiply spent energy to move piston trough liquid and which condition should be meet to get more energy then energy is spent.

### DETAILED DESCRIPTION OF INVENTION

On the sketch # 1 is shown a device that is able to generate more energy than energy is spent. The device is made of an L-shaped water container with specifically designed piston partially in the container.

The whole device is submerged in deep static wide-open water. Assume, for example, that the dimensions of the device are as on the sketch # 1. Assume that the piston is made of a solid material whose weight is 99% of the same volume of the water, meaning that the piston is 1% lighter than the water.

Assume, for example, that the volume of the piston is the same as volume of the tube of the container. If the piston is lighter than water, the piston will be pushed up by buoyant force of the water, but mechanically limited to move farther and will stay where it is.

If 2% the weight of the piston is added at the top of the piston, that will make the piston heavier than the water for 1% of the weight.

As heavier than water, the piston will move down one meter by gravitational force, together with the added weight until is stopped mechanically. What happens when the piston moves down one meter? The piston makes space for water in the tube of the container to move down for 1 meter. In example with the given dimensions, when the piston moves 1 meter down, 100 cubic meters of water in the tube moves down 1 meter. Moving mass of water volume of 100 cubic meters for one meter in direction of gravity will generate energy. If additional weight is removed from the top of the piston, the piston becomes lighter for 1% of the weight of the water.

As lighter, the piston will be pushed up by buoyant forces and will take its previous position itself. Water from inside the container will move out of the container through valves with little or no resistance. Valves should be designed to be open when the piston moves up but closed when piston moves down, which is easy to realize. To repeat the process we need to move additional weight 1 meter up (spent energy) and put it at the top of the piston. Removing and lifting up additional weight 1 meter, we make the piston to move up and down 1 meter, but at the same time the mass of the water in the tube moves down 1 meter. As a result of this process more energy is generated than energy is spent to move up and down additional weight. Actually, the same amount of mass is moved up and down, for the same distance, but when mass is moved up, two forces are applied, gravitational and buoyant forces. How buoyant force is equal to the weight of water, theoretically, piston has no weight if it is made of solid material whose weight is the same as the weight of the water. To move the piston with “no weight” we need much less force to apply. When the piston moves down, water in the tube of the container moves down under gravitational force only, there is no buoyant force in opposite direction. Let's calculate how much energy we have to spend to make the piston move up and down and how much energy water in the tube generates when moves one meter down. Assume that the volume of the tube and volume of piston are the same, 100 cubic meters:
Wp=100000 kg=1000000 N−weight of piston
0.02 Wp=2000 kg=20000 N−additional weight
Wt=100000 kg=1000000 N−weight of water in the tube

Moving additional weight 1 m up we have to spend:
Es=20000N×1 m=20000 J

When 100 cubic meters of water moves in the direction of gravity one-meter, energy released is:
Er=1000000N×1 m=1000000 J.

Coefficient of multiplication of energy is:
m=1000000 J/20000 J=50 times, in this example.

Different sizes give different multiplication coefficient.

This example is shown only to make process more obvious that is possible to get more energy than energy is spent. There are better ways with different dimensions, which can provide higher multiplication coefficient, as device shown on sketch # 2.

Assume that the volume of the piston 1 m×1 m×1 m, which is 1 cubic meter. As in previous example, the piston is made from solid material whose weight is 99% as the same volume of water. If there is no additional weight at the top of the bar, the whole piston including the bar will be pushed up by the buoyant force of the water and stay where it is. If we add 2% of the weight of the piston at the top of the bar, that will make the whole piston heavier than the water for 1% of weight. As heavier than water, the piston will move down 1 m under gravitational force, together with the added weight. Let's say highs H on sketch #2 is 100 m and the cross section area of the tube is one square meter, which gives a volume of the tube 100 cubic meters.

Removing and lifting up additional weight and putting on the top (spending energy) we make the piston to move up and down. As a result of this process water in the tube moves down and generate energy. Let's calculate, in this example, how much energy we have to spend to make the piston to move up and down and how much energy water in the tube generate when moves one meter down, if the dimensions are as on sketch # 2.
Wp=1000 kg=10000 N−weight of piston
0.02 Wp=20 kg=200 N−additional weight
Wt=100 000 kg=1000 000N−weight of water in the tube

Moving additional weight 1 m up we have to spend:
Es=200 N×1 m=200J.

When 100 cubic of water moves down one meter in direction of gravity, energy released is:
Er=1000 000 N×1 m=1000 000J.

Coefficient of multiplication of energy is:
m=1000 000 J/200J=5000 times.

In similar way piston may be designed as on sketch # 3 with the same results as on sketch # 1.

The piston may be designed as on sketch # 4 and generate the same results as the device on sketch # 2, but in these examples, energy spent to provide the piston to be moved up and down does not depend of the depth of water, it is always constant no matter how deep piston is in the water. If the piston is deeper in the water, greater coefficient of multiplication is. Different sizes give different multiplication coefficient. It is obvious that is possible to multiply energy using gravitational and buoyancy forces in ways described above. It is simple as that.

In a similar way we can generate energy as is shown on sketch # 5. Device shown on sketch # 5 is made of one tube and one piston that is able to move through the tube at the bottom of the tube and the whole device is submerged in the wide open static water or any other liquid. The piston is made from a solid material whose density is equal to the density of water. In the water, the piston is in a state of neutral buoyancy, meaning that there are no forces to pull the piston down, up or aside. The piston will stay where it is if no outside forces are applied to move it. The tube is made of a solid material, closed at the bottom with a valve that opens when water exits the tube and closes when the piston goes out, how is shown on Sketch #5.

As any multiplier, if no energy is spent no energy can be generated. Everything stays in balance as it is. In order to get some energy we must spend some energy first. How the piston, virtually float in the water, to move it one meter from the left to the right, we have to overcome the resistance of the moving piston though the water. It depends of density of water and the shape of the piston. This resistance is relatively low. If dimensions are as on sketch, removing one cubic meter of the piston from inside the tube makes space for the water above the piston to move down one meter. The volume of the water above the piston in this example is one hundred cubic meters.

That means when piston, whose volume is one cubic meter, moves horizontally out of the tube one meter, one hundred cubic meters of water moves down one meter in the direction of gravity, and generate energy. The second half of cycle is to move the piston back in it's previous position. To do that, some energy must be spent, but energy is not produced. When the piston is pushed back, water from inside the tube goes through the valve out, horizontally. The valve should be made in a way that it is closed when the piston moves out, but open when the piston moves in the tube.

How to use energy released? As by sketch # 6, at the top of the tube we can make an opening with a propeller under, and when the water in the tube moves down the water outside at the top moves in, pushing the fins of the propeller and forcing propeller to rotate. Energy is taken from the rotation of the propeller. To the axis of the propeller can be attached something to do work.

To produce energy in both half of cycles, we may make another equivalent device in line with first one with connected pistons. Then, when one piston moves out of one tube, another piston moves into the second tube. When one produce energy another does not and vice versa, sketch # 7.

Obviously, the bottom of the tube may be much wider, and the piston may be much bigger. To move the bigger piston more energy is spent, but at the same time, much more energy is produced.

Finally, we can make many pairs of devices as we want as on sketch # 7 in line, connect all pistons with solid connection, and multiply energy as much as we want. When the big piston is moved forward, half of the devices will produce energy, other half will not and vice versa.

What I claim as my invention is:

1. Any technique used with any container submerged in any liquid can generate more energy than energy is spent if spent energy, gravitational and buoyant forces are applied to force liquid to exit the container at the bottom of the container and to enter into container at the top of the container.
